(19) United States
(12) Patent Application Publication
(10) Pub. No.: US 2021/0100289 A1
(43) Pub. Date: Apr. 8, 2021

(54) Consumable Cartridge For An Aerosol Generation Device

(71) Applicant: JT International S.A., Geneva (CH)

(72) Inventor: Thomas Johaentges, Schweich (DE)

(73) Assignee: JT International S.A., Geneva (CH)

(21) Appl. No.: 17/048,391

(22) PCT Filed: May 3, 2019
(86) PCT No.: PCT/EP2019/061394

§ 371 Date: Oct. 16, 2020

(30) Foreign Application Priority Data
May 10, 2018 (EP) 18171673.9

(51) Int. Cl. A24F 40/46; A24F 40/42; A24F 40/20; H05B 3/10

(52) U.S. Cl. CPC A24F 40/46; A24F 40/42; H05B 3/03; H05B 3/10; H05B 2203/034; A24F 40/20

(57) ABSTRACT

A consumable cartridge for an aerosol generation device includes a casing, a heating element provided within the casing and arranged to be heated by receiving energy from the aerosol generation device, and a solid or semi-solid aerosol forming material provided within the casing that forms an aerosol when heated. The heating element includes a plurality of thermally or electrically conducting wires and/or fibres.

### CROSS-REFERENCE TO RELATED APPLICATIONS

The present application is a national phase entry under 35 U.S.C. § 371 of International Application No. PCT/EP2019/061394, filed May 3, 2019, published in English, which claims priority to European Application No. 18171673.9 filed May 10, 2018, the disclosures of which are incorporated herein by reference.

### BACKGROUND OF THE INVENTION

The present invention relates to a consumable cartridge for use with an aerosol generation device.

A number of new generation smoking devices have been introduced that seek to provide an alternative to conventional cigarettes. One such device is described in EP 2772148A2. In this arrangement a smoking device is provided with a mouthpiece, a casing, an electrical heater and a battery. A consumable cartridge can be installed in the device adjacent the heater in the smoking device. The consumable cartridge has a casing which encloses tobacco material. The heater can heat the casing of the cartridge, causing the tobacco contained within to heat without burning, which releases an aerosol. This aerosol or vapour can then be inhaled by a user through the mouthpiece.

As described above, consumable cartridges known in the art normally heat a casing, which in turn heats an aerosol forming material within the casing. It is desirable to maximise the heat transferred to the tobacco material for a more effective and efficient use of smoking device and consumables, and to provide a casing that can be handled more easily.

### BRIEF SUMMARY OF THE INVENTION

According to an aspect of the invention there is provided a consumable cartridge for an aerosol generation device, the consumable cartridge comprising: a casing; a heating element provided within the casing arranged to be heated by receiving energy from the aerosol generation device, wherein the heating element comprises a plurality of thermally or electrically conducting wires and/or fibres; and a solid or semi-solid aerosol forming material provided within the casing adapted to form an aerosol upon receiving heat from the heating element.

In this way, it is possible for heat to be generated within a casing that contains an aerosol forming material, such as tobacco. The cartridge may have a generally cylindrical shape with a circular cross-section. The casing can be handled and allows the aerosol forming material to be transported easily. The casing may be made from an insulating material such as glass to allow a user to see inside the casing. The casing may also be made from other materials, such as paper, cardboard, ceramics or metals. The plurality of thermally or electrically conducting wires and/or fibres may be made from metal, such as steel. The provision of a heating element within the casing means that the heating element may be close to the aerosol forming material so that heat can be efficiently supplied to the aerosol forming material. Therefore, by providing a casing and a separate heating element heat generated by the heating element may directly heat the aerosol forming material. Further, by using a combination of a plurality of metal wires for a heater material, the heater has a large outer surface (i.e. for effectively transferring heat to the aerosol forming material) that has been provided at cheap cost.

Preferably, the heating element comprises a plurality of fibres, and wherein each fibre is in contact with at least one additional fibre. The fibres may be interlocked and/or overlapped and thereby the interlocked/overlapped fibres are longer than the casing. In this way, it is possible for the plurality of fibres to provide an interconnected network, or bundle, of fibres. The fibres may extend from one end of the cylindrical casing to the other end, such that the heating element provides heat within the casing across the full length of the casing. The fibres may be made of a heat-conducting material such as steel wool. Therefore, the contacts between individual fibres allow energy, such as heat energy or electrical energy, to travel effectively throughout the interconnected network of fibres and heat the aerosol forming material.

Preferably, the average length of fibres of the plurality of fibres is less than a length of the casing. In this way, the energy received from the aerosol generation device may be more effectively distributed through the plurality of fibres. This means that the plurality of fibres would be better utilised for its purpose as a heating element compared to the only a small portion of the plurality of fibres being heated. There may be individual fibres that have lengths longer than the length of the casing, and the longer individual fibres are in a folded or curved arrangement to provide a denser distribution of interconnected fibres.

The aerosol forming material may be arranged between the casing and the heating element. In this way, it is possible for the majority of heat provided by the heating element to be transferred to the aerosol forming material. For example, the aerosol forming material wraps around the heating element such that heat from the heating element must pass through the aerosol forming material before reaching the casing. An inner surface of the casing may be made from an insulating and/or heat-reflective material to keep the heat within the casing. The aerosol forming material may be in the form of more than two sheets that are arranged between the casing and the heating element. The sheets may be layered relative to each other, and largely cover the internal cylindrical surface of the casing.

The heating element may be arranged between the casing and the aerosol forming material. In this way, it is possible for the aerosol forming material to be contained within the heating element. An inner surface of the casing may be made from an insulating and/or heat-reflective material to further keep the heat within the casing.

The aerosol forming material and the heating element may comprise a plurality of respective fibres interspersed in a single bundle. In this way, it is possible for the aerosol forming material to be more heated more evenly. The space surrounding an individual fibre can be filled with aerosol forming material rather than an adjacent fibre and/or air. For example, the aerosol forming material may be interspersed within or around a plurality of heating element fibres. The aerosol forming material may be distributed around a large proportion of each fibre such that the heat from each fibre may be used to heat the aerosol forming material. The aerosol forming material may be in the form of strips and/or ground particles that can be inserted into and/or scattered over the plurality of fibres. The distribution of aerosol forming material in relation to the heating element is provided in a more random arrangement. Therefore, less heat would be wasted in heating spaces between the plurality of fibres where no aerosol forming material is present. Alternative methods to combine the aerosol forming material to the heating element include pressing or rolling pieces of steel wool in a bed of loose tobacco particles.

The aerosol forming material and the heating element may be rolled together. In this way, it is possible to provide a larger surface area of the heating element to heat the aerosol forming material. For example, the aerosol forming material can be layered relative to the heating element (e.g. above or below a sheet of the heating element) such that the layer of aerosol forming material and the heating element layer are rolled into a spiral arrangement to be provided within the casing. It is also possible to improve heating efficiency by separating adjacent layers of the heating element with the aerosol forming material such that there is no connection between adjacent layers of the heating element. The aerosol forming material may also be provided between the heating element and the casing, so that the aerosol forming material acts as heat insulation by retaining the heat generated by the heating element within the cartridge.

Alternative configurations for arranging an aerosol forming material and a heating element within a casing of a consumable cartridge include alternating concentric layers of the aerosol forming material and meshes of the heating element, or creating a three-dimensional lattice of mesh sheets provided in a volume of aerosol forming material.

Preferably, the consumable cartridge further comprises two electrodes, wherein the two electrodes are configured to receive electrical energy from the aerosol generation device and wherein the two electrodes provide the electrical energy to the heating element. In this way, the heating element acts as an electrical resistor and heat is generated by resistive heating, where the fibres provide electrical resistance between a positive electrode and a negative electrode of the cartridge that are in contact with the heating element. The electrical resistance of the fibres may be adjusted by the fibre weight, where a higher fibre weight provides a lower electrical resistance. As an example, an aerosol generation device can work well with a cartridge comprising a plurality of fibres having a fibre quantity of 100 mg, which provides an electrical resistance of approximately 0.5Ω.

The positive electrode and the negative electrode may be located at either end of the cartridge and are configured to receive electrical energy from a battery in an aerosol generation device. In another example, the plurality of fibres can be twisted and the electrodes may be located at a same end of the cartridge.

Preferably an outer surface of the heating element is oxidised. In this way, the surface of the heating element is not electrically conductive and heat is transferred from the heating element to the aerosol forming material through the oxidised outer layer by conduction. By providing a stable outer surface, the possibility of burning the aerosol forming material is mitigated. For example, the outer surfaces of the plurality of fibres can be oxidised after the desired arrangement of fibres is achieved. In another example, the surface or surfaces of the mesh that is directed toward the aerosol forming material are oxidised.

The heating element may comprise a mesh.

The mesh gauge and mesh size may be suitably selected such that the aerosol forming material can be substantially contained within the heating element. Alternatively, the mesh size and mesh gauge may be selected so that loose particles of the aerosol forming material can fall between the casing and the heating element.

The mesh sheet heating element may be a stainless steel mesh that is configured to heat by resistive heating, where the mesh connects a positive electrode and a negative electrode of the cartridge. The electrical resistance of the mesh can be adjusted by the width of the mesh piece, where a wider mesh piece provides a lower electrical resistance. As an example, an aerosol generation device can work well with a cartridge comprising a mesh sheet heating element having a length of 65 mm and a width of 10 mm, which provides an electrical resistance of approximately less than 0.65Ω.

Alternatively one or more heaters may be provided in an aerosol generation device, and the cartridge further comprises one or more contact points that are arranged to be in contact with the one or more heaters such that the heating element (i.e. the fibres and/or wires) is heated by conduction. The one or more contact points may be located at one end of the cartridge or at both ends, depending on the arrangement of heaters on an aerosol generation device.

The aerosol forming material, or vaporisable substance (e.g. tobacco), may be any suitable substance capable of forming a vapour. The substance may be solid or semi-solid substance. The substance may comprise plant derived material and in particular, the substance may comprise tobacco. Typically, the vaporisable substance is a solid or semi-solid tobacco substance. Example types of vapour generating solids include powder, granules, pellets, shreds, strands, porous material, foam or sheets.

Preferably, the vaporisable substance may comprise an aerosol-former, or carrier material. Examples of aerosol-formers include polyhyrdric alcohols and mixtures thereof such as glycerine or propylene glycol. Typically, the vaporisable substance may comprise an aerosol-former content of between approximately 5% and approximately 50% on a dry weight basis.

Preferably, the vaporisable substance may comprise an aerosol-former content of approximately 15% on a dry weight basis. The aerosol forming material may also include other materials, such as a flavouring, and water etc.

According to another aspect of the invention there is provided an aerosol generation device, comprising: a battery; and the consumable cartridge of any of the preceding claims, wherein the aerosol forming material can form an aerosol upon receiving heat that is formed by the heating element receiving energy from the battery.

The aerosol generation device may have a cartridge holder portion and a controller section. The cartridge holder portion may have an outlet through which a user of the aerosol generation device may inhale an aerosol. The cartridge holder portion may also have a cavity in which the cartridge can be inserted. The cartridge holder portion may also have a positive electrode connection for connecting the positive electrode of the cartridge to a positive terminal of the battery.

The battery may be located in a controller section. The battery may also have a negative terminal that is configured to be directly connected to the negative electrode of the cartridge. The controller section may have an inlet through which air can flow into a constructed aerosol generation device. The aerosol generation device may allow a passage of airflow, by which air enters the aerosol generation device via the inlet, and where the air flows into and through the cartridge via holes or perforations in the cartridge and where the air and aerosol from the cartridge exits the aerosol generation device via the outlet.

According to another aspect of the invention there is provided a method of generating aerosol comprising: inserting a consumable cartridge comprising a casing, a heating element and an aerosol forming material into a chamber of an aerosol generating device, wherein the heating element and the aerosol forming material are provided within the casing; providing energy from the aerosol generating device for the heating element to be heated; and heating the aerosol forming material in the consumable cartridge.

### BRIEF DESCRIPTION OF THE DRAWINGS

Embodiments of the invention are now described, by way of example, with reference to the drawings, in which:

FIG. 1 is a cross-sectional view of a cartridge in an embodiment of the invention;

FIG. 2 is a cross-sectional view of a cartridge in another embodiment of the invention;

FIG. 3 is a cross-sectional view of a cartridge in another embodiment of the invention;

FIG. 4 is a cross-sectional view of a cartridge in another embodiment of the invention;

FIG. 5 is a side view of a cartridge comprising two electrodes in an embodiment of the invention; and

FIGS. 6A and 6B are an exploded side view and a constructed side view of the cartridge depicted in FIG. 5 in an aerosol generation device.

### DETAILED DESCRIPTION

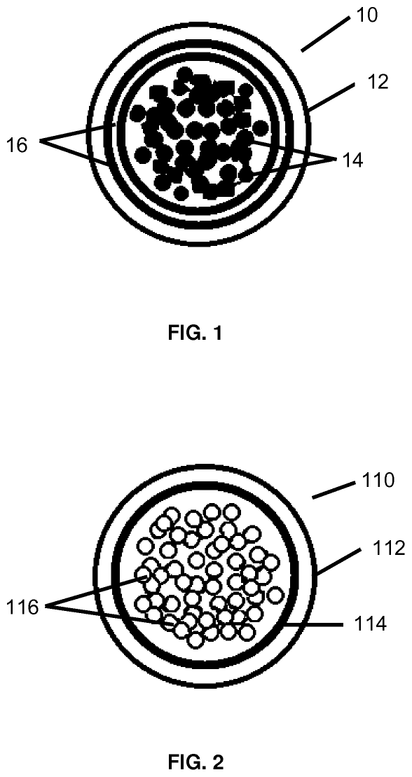

FIG. 1 shows a cartridge 10 in a first embodiment of the invention. The cartridge 10 has a generally cylindrical shape with a circular cross-section. The cartridge 10 has a casing 12 which accommodates a heating element 14 and an aerosol forming material 16, such as tobacco, within. A number of other products and ingredients may be provided within the casing 12, as will be appreciated by a person skilled in the art.

The casing 12 can be made from an insulating material such as glass to allow a user to see inside the casing 12. The casing 12 may also be made from other materials, such as papers, ceramics or metals.

The heating element 14 comprises a plurality of fibres, where each fibre is in contact with an additional fibre to form an interconnected network, or bundle, of fibres. The fibres extend from one end of the cylindrical casing 12 to the other end, such that the heating element 14 provides heat within the casing 12 across the full length of the casing 12. The fibres can be made from a heat-conducting material such as steel wool. As will be appreciated by a person skilled in the art, a number of other heat-conducting materials may be used for the heating element 14.

The heating element 14 is configured to heat by resistive heating, where the fibres provide electrical resistance between a positive electrode and a negative electrode of the cartridge 10 (not shown) that are in contact with the heating element 14. The electrical resistance of the fibres can be adjusted by the fibre weight, where a higher fibre weight provides a lower electrical resistance. As an example, an aerosol generation device can work well with a cartridge 10 comprising a plurality of fibres having a fibre quantity of 100 mg, which provides an electrical resistance of approximately 0.5Ω.

The positive electrode and the negative electrode may be located at either end of the cartridge 10 and are configured to receive electrical energy from a battery in an aerosol generation device. Alternatively, the plurality of fibres can be twisted, and the electrodes may be located at a same end of the cartridge 10.

Alternative methods or systems in heating the heating element 14 would readily occur to a person skilled in the art. For example, one or more heaters can be provided in an aerosol generation device, and the cartridge 10 further comprises one or more contact points (not shown) that are arranged to be in contact with the one or more heaters such that the heating element 14 is heated by conduction. The one or more contact points can be located at one end of the cartridge 10 or at both ends, depending on the arrangement of heaters on an aerosol generation device.

The aerosol forming material 16 is in the form of two sheets that are arranged between the casing 12 and the heating element 14. The sheets are layered relative to each other, and largely cover the internal cylindrical surface of the casing 12. As will be appreciated by a person skilled in the art, the aerosol forming material may consist of different numbers of sheets or take other forms, such as strips or ground tobacco particles.

FIG. 2 shows a cartridge 110 in a second embodiment of the invention. The cartridge 110 has a casing 112 which accommodates a heating element 114 and an aerosol forming material 116 within.

In this arrangement the heating element 114 is arranged between the casing 112 and the aerosol forming material 116. The heating element 114 is in the form of a mesh sheet. The aerosol forming material 116 is in the form of strips or loose particles. As will be appreciated by a person skilled in the art, the aerosol forming material may take other forms, such as sheets.

The mesh gauge and mesh size are suitably selected such that the aerosol forming material 116 can be substantially contained within the heating element 114. Alternatively, the mesh size and mesh gauge can be selected so that loose particles of the aerosol forming material 116 can fall between the casing 112 and the heating element 114.

The mesh sheet heating element 116 can be a stainless steel mesh that is configured to heat by resistive heating, where the mesh connects a positive electrode and a negative electrode of the cartridge 110. The electrical resistance of the mesh can be adjusted by the width of the mesh piece, where a wider mesh piece provides a lower electrical resistance. As an example, an aerosol generation device can work well with a cartridge 110 comprising a mesh sheet heating element 116 having a length 65 mm and a width of 10 mm, which provides an electrical resistance of approximately 0.65Ω or less.

Alternatively, the mesh sheet can be heated by conductive heating using one or more heaters in an aerosol generation device, and the cartridge 110 further comprises one or more contact points (not shown) that are arranged to be in contact with the one or more heaters.

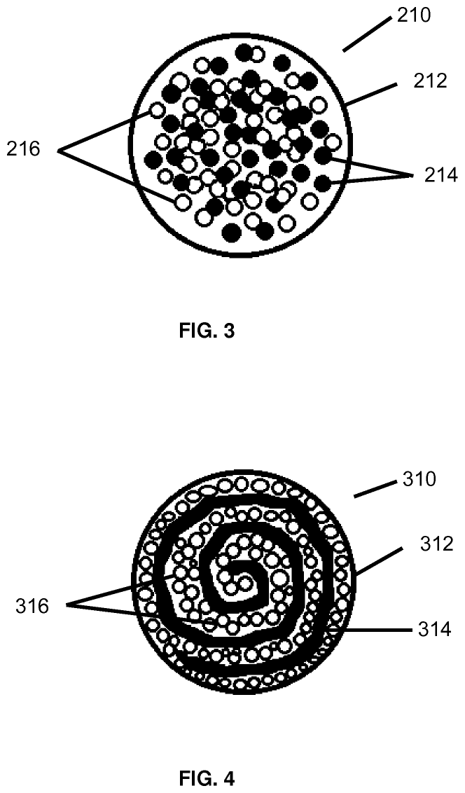

FIG. 3 shows a cartridge 210 in a third embodiment of the invention. The cartridge 210 has a casing 212 which accommodates a heating element 214 and an aerosol forming material 216 within.

In this arrangement the heating element 214 comprises a plurality of fibres, such as steel wool, and the aerosol forming material 216 is interspersed with the heating element 214 to form a single bundle of fibres. The aerosol forming material 216 is in the form of strips and/or ground particles that can be inserted into and/or scattered over the plurality of fibres. The distribution of aerosol forming material 216 in relation to the heating element 214 is provided in a more random arrangement. Alternative methods to combine the aerosol forming material 216 to the heating element 214 would readily occur to a person skilled in the art, such as pressing or rolling pieces of steel wool in a bed of loose tobacco particles. The heating element 214 can be arranged to be heated by resistive heating or conductive heating as described above.

FIG. 4 shows a cartridge 310 in a fourth embodiment of the invention. The cartridge 310 has a casing 312 which accommodates a heating element 314 and an aerosol forming material 316 within.

In this arrangement the aerosol forming material 316 can be in the form of sheets, strips or loose particles that are layered above or below a sheet of the heating element 314, so that when the sheet of the heating element 314 is rolled up the aerosol forming material 316 is rolled within the heating element 314. The aerosol forming material 316 separates adjacent layers of the heating element 314 for efficient heating such that there is no connection between adjacent layers of the heating element 314. The aerosol forming material 316 can also be provided between the heating element 314 and the casing 312, so that the aerosol forming material 316 acts as heat insulation by retaining heat generated by the heating element 314 within the cartridge 310. Alternative methods to form a spiral arrangement or a “Swiss roll cake” or roulade arrangement would readily occur to a person skilled in the art. The heating element 314 can be arranged to be heated by resistive heating or conductive heating as described above.

Alternative configurations for arranging an aerosol forming material and a heating element within a casing of a consumable cartridge would readily occur to a person skilled in the art, such as alternating concentric layers of the aerosol forming material and meshes of the heating element, or creating a three-dimensional lattice of mesh sheets provided in a volume of aerosol forming material.

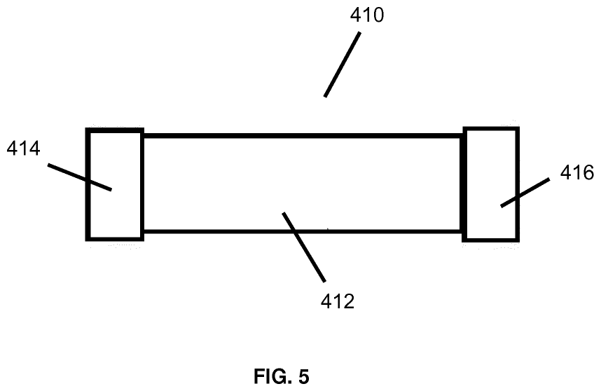

FIG. 5 shows a cartridge in an embodiment of the invention. The cartridge 410 has a casing 412 which accommodates a heating element (not shown) and an aerosol forming material (not shown). The cartridge 412 has a generally cylindrical shape with a circular cross-section, and the cartridge 412 has a positive electrode 414 and a negative electrode 416 at either end, where the electrodes 414 and 416 are configured to receive electrical energy from a battery (not shown).

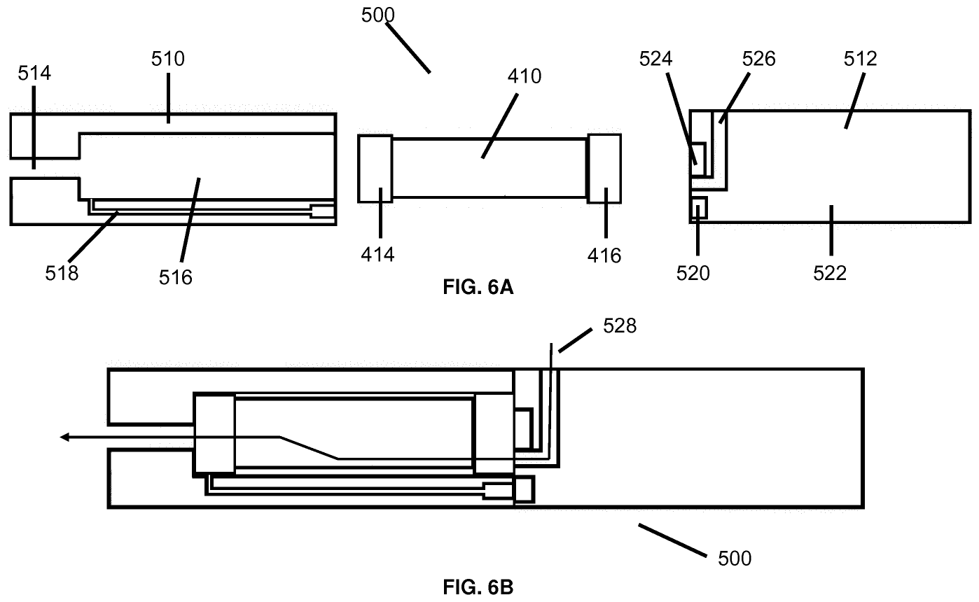

FIG. 6A shows the cartridge depicted in the fifth embodiment of the invention in an aerosol generation device 500. The aerosol generation device 500 has a cartridge holder portion 510 and a controller section 512.

The cartridge holder portion 512 has an outlet 514 (or mouthpiece) through which a user of the aerosol generation device may inhale an aerosol. The cartridge holder portion 512 also has a cavity 516 in which the cartridge 410 can be inserted. As will be appreciated by a person skilled in the art, the cartridge holder portion 512 can be made of a number of materials, such as glass or plastic.

The cartridge holder portion 512 also has a positive electrode connection 518 for connecting the positive electrode 414 of the cartridge 410 to a positive terminal 520 of a battery 522. The battery 522 is located in a controller section 512. The battery 522 also has a negative terminal 524 that is configured to be directly connected to the negative electrode 416 of the cartridge 410. FIG. 6B shows the aerosol generation device 500 in its constructed form and how the positive and negative terminals 520 and 524 of the battery 522 are connected to the positive and negative electrodes 414 and 416 of the cartridge 410.

The controller section 512 has an inlet 526 through which air can flow into a constructed aerosol generation device 500. FIG. 6B shows a passage of airflow 528, where air enters the aerosol generation device 500 via the inlet 526, and where the air flows into and through the cartridge 410 via holes or perforations in the cartridge 410 (not shown) and where the air and aerosol from the cartridge 410 exits the aerosol generation device 500 via the outlet 514.

Alternative configurations of providing electrode connections between a battery and electrodes on a consumable cartridge would readily occur to a person skilled in the art.

1. A consumable cartridge for an aerosol generation device, the consumable cartridge comprising:
a casing;
a heating element provided within the casing arranged to be heated by receiving energy from the aerosol generation device, wherein the heating element comprises a plurality of thermally or electrically conducting wires and/or fibres; and
a solid or semi-solid aerosol forming material provided within the casing adapted to form an aerosol upon receiving heat from the heating element.

2. The consumable cartridge of claim 1, where the heating element comprises a plurality of fibres, and wherein each fibre is in contact with at least one additional fibre.

3. The consumable cartridge of claim 2, wherein the average length of fibres of the plurality of fibres is less than a length of the casing.

4. The consumable cartridge of claim 1, wherein the aerosol forming material is arranged between the casing and the heating element.

5. The consumable cartridge of claim 1, wherein the heating element is arranged between the casing and the aerosol forming material.

6. The consumable cartridge of claim 1, wherein the aerosol forming material and the heating element comprise a plurality of respective fibres interspersed in a single bundle.

7. The consumable cartridge of claim 1, wherein the aerosol forming material and the heating element are rolled together.

8. The consumable cartridge of claim 1, further comprising two electrodes, wherein the two electrodes are configured to receive electrical energy from the aerosol generation device and wherein the two electrodes provide the electrical energy to the heating element.

9. The consumable cartridge of claim 8, wherein an outer surface of the heating element is oxidised.

10. The consumable cartridge of claim 1, wherein the heating element comprises a mesh.

11. An aerosol generation device, comprising:
a battery; and
the consumable cartridge of claim 1, wherein the aerosol forming material can form an aerosol upon receiving heat that is formed by the heating element receiving energy from the battery.

12. A method of generating aerosol comprising:
inserting a consumable cartridge comprising a casing, a heating element and a solid or semi-solid aerosol forming material into a chamber of an aerosol generating device, wherein the heating element and the aerosol forming material are provided within the casing, and wherein the heating element comprises a plurality of thermally or electrically wires and/or fibres;
providing energy from the aerosol generating device for the heating element to be heated; and
heating the aerosol forming material in the consumable.
